(19) United States
(12) Patent Application Publication
(10) Pub. No.: US 2017/0078725 A1
(43) Pub. Date: Mar. 16, 2017

(54) METHOD FOR MANAGING THE RECOVERY OF ADVERTISING CONTENT

(71) Applicant: Orange, Paris (FR)

(72) Inventors: Matthieu Gendrin, St Aubin d'Aubigne (FR); Renaud Cazoulat, Saint Gregoire (FR); Erwan Morvillez, Rennes (FR)

(21) Appl. No.: 15/262,753

(22) Filed: Sep. 12, 2016

(30) Foreign Application Priority Data
Sep. 10, 2015 (FR) 1558448

(51) Int. Cl. H04N 21/266; H04N 21/472; H04N 21/45; H04N 21/81; H04L 29/08; H04N 21/845

(52) U.S. Cl. CPC H04N 21/266; H04L 67/306; H04N 21/845; H04N 21/4532; H04N 21/812; H04N 21/47202

(57) ABSTRACT

A method managing the recovery of content. The method includes content of a first type (CNT) and content of a second type (PUB). Certain time intervals (PL1-PL3) are dedicated to reading content of the second type. The content is capable of being manipulated via a control device. According to the method, reception of a command to manipulate content of the second type during a time interval instigates recovery of a different content of the second type.

### CROSS-REFERENCE TO RELATED APPLICATIONS

This Application claims priority to and the benefit of French Patent Application No. FR1558448, filed Sep. 10, 2015, the content of which is incorporated herein by reference in its entirety.

### TECHNICAL FIELD

The invention relates to a method for managing the recovery of content, in particular audio and/or video advertising.

The invention applies to all types of content, whether it is broadcast live or pre-recorded. It should be noted that the pre-recorded mode is offered by means of television on demand or video on demand applications, or any other equivalent tool.

Generally, the invention can be implemented in all types of media in which the content is digital content; media of this type are, for example, radio, television, social network media (Facebook, Twitter, etc.), video games, Internet, etc. The example below will be based on television, quite specifically on a television on demand application. However, the invention is not limited to this example, but may extend to other types of usage.

### PRIOR ART

Two types of multimedia content will be distinguished below, i.e.:
first multimedia content which concerns content requested by a consumer, such as, for example, a video;
second multimedia content, for example concerning an advertisement, referred to below by the term advertisement;

Today, a consumer may order content of the first type from a communication device via a communication network. The communication device concerned is, for example, a digital decoder connected to an Internet network access gateway. For this purpose, the decoder is equipped with means such as a television on demand (TVoD) application. This application (TVoD) allows, in particular, content to be ordered and its recovery on a recovery device to be requested; in the context of television on demand, the recovery of the ordered content is increasingly accompanied by a recovery of one or indeed more advertisements. The advertisements may be recovered before the recovery of the video or during the video.

In some media, commercial audiovisual (audio or video) advertising is structured in the form of “advertisement tunnels” where advertisements are concatenated without possible action on the content which would allow, for example, an acceleration of the reading of the advertisement or a transfer to the ordered content. The aim of this model is to force the user wishing to access the video to read at least one advertisement or a part thereof.

The inventors have noted that some commands are inhibited during the time period devoted to the advertisements; in other words, in order to guarantee that the user sees the entire advertisement, commands such as fast forward or transfer to the next content are disabled; a message on the screen may possibly indicate that the command in question is not allowed. This method of broadcasting forces the user (spectator) to follow advertisements, some of which will be of no interest to him. These “irrelevant” advertisements represent an annoyance for the user, but also a loss of revenue for the broadcaster who could have shown a more targeted advertisement instead.

One or more exemplary embodiments of the invention offers a solution which does not have the disadvantages of the prior art.

### SUMMARY

For this purpose, according to one functional aspect, the subject matter of an exemplary embodiment of the invention is a method for managing the recovery of content including content of a first type and content of a second type, a time interval being dedicated to the reading of the content of the second type, the content being capable of being manipulated via a control device, characterized in that a reception of a command to manipulate content of the second type in the time interval instigates the selection of a different content of the second type for recovery.

According to an exemplary embodiment of the invention, during the aforementioned, predefined, time interval, a command intended to be disabled in the prior art becomes enabled; in this case, a command such as fast forward or transfer to the next content is not inhibited but, on the contrary, instigates the recovery of a different content of the second type, for example a different advertisement.

More generally, some or all of the manipulation commands available on the control device are transformed into commands for selecting a different content of the second type.

It should be noted here that a disabled command means that the command, when executed, does not perform its primary function. For example, if the function of a command is to perform a fast-forward on content, when it is disabled this means that the fast-forward is not performed; in this case, the function of the command is either modified or ignored. Modifying a function consists, for example, in replacing the primary function with a different function, for example a display of a message on a screen, informing, for example, that the command cannot be executed.

An exemplary embodiment of the invention can be applied to radio and television advertisement tunnels. An exemplary embodiment of the invention allows the listener (/spectator) not to watch advertisements which are of no interest to him. The benefit for the announcer is, on the one hand, a gain in the attention of the listener (/spectator) and, on the other hand, a greater number of advertisements that are of interest to the listener (/spectator) in the same defined time period or time interval.

This results in a recovery time period at least equal to the predefined period. In fact, as indicated below, this recovery time duration may be greater than the defined time interval.

In other words, at least until the end of the defined time interval, a reception of a command to manipulate a content of the second type in the time interval instigates the selection of a different content of the second type for recovery.

According to one particular embodiment of the invention, the content of the second type is selected according to a profile created on the basis of a history of the recovered content of the second type. More particularly, the profile is based on content of the second type recovered beyond a certain time duration. In this way, the advertisements which replace an advertisement are chosen judiciously, in particular according to the tastes of the user. The profile changes over time in such a way as to reduce the number of manipulation commands received during the time interval.

According to one particular embodiment of the invention, which may be implemented alternatively or cumulatively with the preceding embodiment, at least one condition is verified before the recovery of the content of the first type. More particularly, a condition is a minimum time duration for recovery of at least one content of the second type. In fact, as the method according to an exemplary embodiment of the invention alters the advertisement recovery times, this embodiment and this variant guarantee fulfillment of conditions linked to the recovery, in particular the minimum recovery time duration required to access content of the first type.

According to one particular embodiment of the invention, which may be implemented alternatively or cumulatively with the preceding embodiments, when the time interval has elapsed, if said at least one condition is not fulfilled, the content manipulation commands are disabled until said at least one condition is fulfilled. In fact, without this variant, it could occur that the conditions are not fulfilled at the end of the interval; in order to ensure that the conditions are fulfilled in all cases, if said conditions are not fulfilled when the time interval has elapsed, the received commands are disabled. This results here in a recovery time duration greater than the predefined time interval.

According to one particular embodiment of the invention, which may be implemented alternatively or cumulatively with the preceding embodiments, a manipulation command is one of the following commands:
a. a move-forward command relating to the content of the second type;
b. a command to transfer to the content of the first type.

A plurality of possible manipulation commands generally exist. According to this embodiment, only some of the manipulation commands are concerned by the invention. For example, only the commands representing a wish to move forward in relation to the content of the second type are concerned.

According to one particular embodiment of the invention, which may be implemented alternatively or cumulatively with the preceding embodiments, the content of the second type is advertising content.

According to one hardware aspect, an exemplary embodiment of the invention relates to a management entity capable of managing the recovery of content, including content of a first type and content of a second type, a time interval being dedicated to the reading of the content of the second type, the content being capable of being manipulated via a control device, characterized in that the entity includes a receiving module capable of receiving a command to manipulate content of the second type in the time interval, and a management module capable of selecting a different content of the second type following the reception of a manipulation command in the interval.

According to a different hardware aspect, an exemplary embodiment of the invention relates to a device including an entity as defined above.

According to a different hardware aspect, an exemplary embodiment of the invention relates to a a computer program capable of being implemented on an entity as defined above, the program including code instructions, said program, when executed by a processor, implementing the steps of the method defined above.

According to a different hardware aspect, an exemplary embodiment of the invention relates to a data medium on which at least one series of program code instructions has been stored for the execution of a method defined above.

### BRIEF DESCRIPTION OF THE DRAWINGS

The invention will be understood more clearly from the reading of the description that follows, given by way of example and set out with reference to the attached drawings, in which:

FIG. 1 shows a schematic view of a computer system illustrating an example embodiment of the invention.

FIG. 2 is an algorithm illustrating the steps of the method according to an exemplary embodiment of the invention.

FIG. 3 illustrates the data exchanges between different elements of a computer system according to one embodiment of the invention.

FIG. 4 is a view representing different advertisements recovered according to the prior art and according to the embodiment shown in FIG. 3.

### DETAILED DESCRIPTION OF AN EXAMPLE EMBODIMENT ILLUSTRATING THE INVENTION

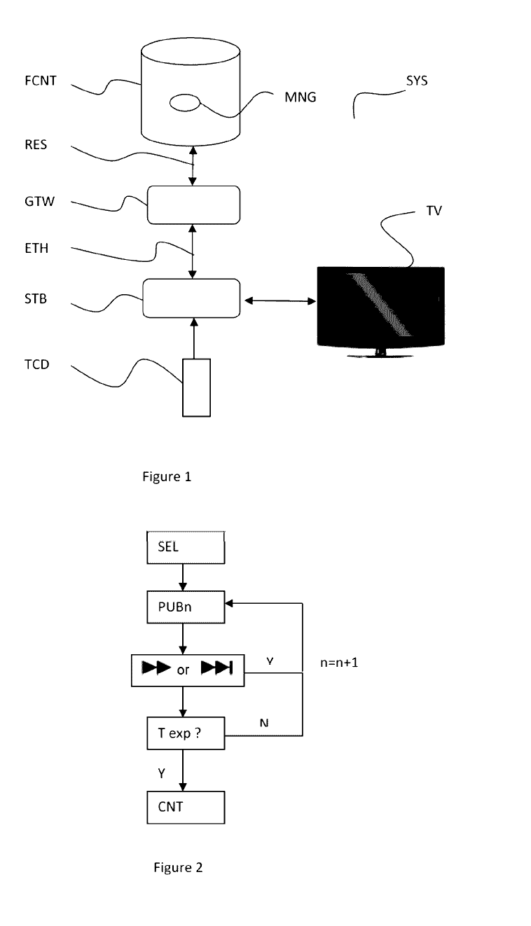

FIG. 1 shows a system SYS including a device STB capable of managing the recovery of content and requesting a recovery of the content.

The content may be stored on a data medium such as a DVD (acronym for “Digital Versatile Disc”), an SD (acronym for “Secure Digital”) card, etc. The content may also originate from a communication network RES to which the device is connected.

In our example, this device STB is a TV decoder capable of communicating with a content provider FCNT via a communication network RES. The function of the decoder is, in particular, to receive content CNT, to transform it if necessary for a recovery on a screen which may be integrated into the decoder or may be outside the decoder. A transformation is, for example, a decoding.

In our example, the decoder is connected to the provider via a home gateway GTW and is connected to the gateway via an Ethernet cable ETH. The gateway includes means for communicating with the network RES. The network is, for example, an extended network WAN (acronym for “Wide Area Network”).

The decoder STB is manipulable via a control device TCD such as a remote control TCD. This remote control comprises a plurality of buttons capable of transmitting respective manipulation commands. On receiving a command, the decoder executes the command.

Among the buttons, some allow a manipulation of recovered content, the main known buttons being, for example, the following:
[symbol] PREV: to replay the content from the start
[symbol] NEXT: to move forward to the next content.
[symbol] (Fast rewind): to play a broadcast using fast rewind.
[symbol] (Fast forward): to play a broadcast in fast-forward mode.

As indicated above, in the context of television on demand, some content may be broadcast by the content provider in exchange for a recovery of one or indeed more advertisements on the TV screen. This content is, for example, the content accessible via a television on demand (acronym TVoD) application, also referred to as “TV catch-up” or “replay TV”. In this context, a selection of content CNT instigates the recovery of an advertisement PUB; the advertisement may be recovered before, during or after the selected content.

It should again be noted here that the invention is not limited to the TVoD application, but extends to all other applications in which content can be recovered. Other possible applications are, for example, “live” television, a video on demand application, etc.

The advertising content is recovered during a time interval having a duration T. According to an exemplary embodiment of the invention, the reception of a manipulation command during the time interval T devoted to the advertisement will, when said command is executed, instigate a provision of an advertisement other than the advertisement currently being recovered.

In our example, the principle is implemented for only some of the manipulation commands, i.e. the commands representing a wish to move forward, referred to below as move-forward commands, i.e. fast forward and move forward to the next content.

It is noted that the consequence of the reception of a manipulation command in the time interval T is a stoppage of an advertisement; the latter is consequently curtailed. A variant described below relates to the management of the recovery time T in that case.

The management is performed by means of a management entity MNG, the location of which is irrelevant. In our example, the entity is located in the service provider FCNT, but could equally well be located outside the provider on the gateway GTW, the decoder STB, the television TV, etc.

The steps of one embodiment will be described with reference to FIG. 2.

During a first phase PH1 (SEL), the user selects content (CNT), for example a video, by means of a television on demand application. A command SEL is transmitted from the remote control TCD to the decoder STB which transfers the command to the provider FCNT.

During a second phase PH2, the content provider broadcasts at least one advertisement PUBn; if there are several of them, one after another. The steps implemented during this second phase PH2 are, for example, as follows. The second phase PH2 furthermore includes the following steps ET1-ET4.

During a first step ET1, the decoder receives a first advertisement PUBn and requests a recovery on the screen of this advertisement.

Then, for the aforementioned time duration T, a command is transmitted from the remote control and is received by the management entity during a second step ET2.

At this stage, the entity MNG then checks during a third step ET3 whether the command is a move-forward command. If so, the management entity requests a broadcast of a new advertisement PUBn+1. If not, the method continues normally by continuing with the recovery of the current advertisement PUBn.

It should be noted that the new advertisement PUBn+1 may originate from a list previously drawn up by the provider, or may be a new advertisement chosen on-the-fly. The advertisements are preferably selected according to a profile created on the basis of a history of the content of the second type recovered beyond a certain time duration. In fact, a recovery of an advertisement beyond a certain time duration may indicate a user predilection for this advertisement or more generally for the category to which the advertisement belongs (automobile category, household category, etc.).

During a step ET4, at the end of the recovery of the advertisement PUBn+1, the management entity checks whether the time duration T provided for the recovery of the advertisements has expired. If not, a new advertisement PUBn+2 is broadcast; if so, the ordered content CNT is recovered.

The embodiment described above may form the subject matter of variants described below.

In our example, in order to obtain a new advertisement, the decoder STB transmits a request to the content provider FCNT. The service provider replies and transmits the new advertisement. According to a first variant, the decoder STB can receive a plurality of advertisements and stores them in a memory (not shown) inside or outside the decoder. During the time interval T, the decoder requests the recovery of the advertisements on the screen. This variant avoids a transmission of a plurality of requests to the content provider.

In this variant, the management entity MNG is preferably located in the decoder STB. In this configuration, the steps of the second phase PH2 are the same as those previously described, except that the entity MNG requests the recovery instead of the broadcast. In other words, the entity checks during a third step ET3 that the command is a move-forward command. If so, the management entity requests a recovery of a new advertisement PUBn+1.

According to a second variant, at least one condition (C) is verified before the recovery of the content of the first type.

The condition C may be a minimum time duration for recovery of at least one content of the second type in the time interval T.

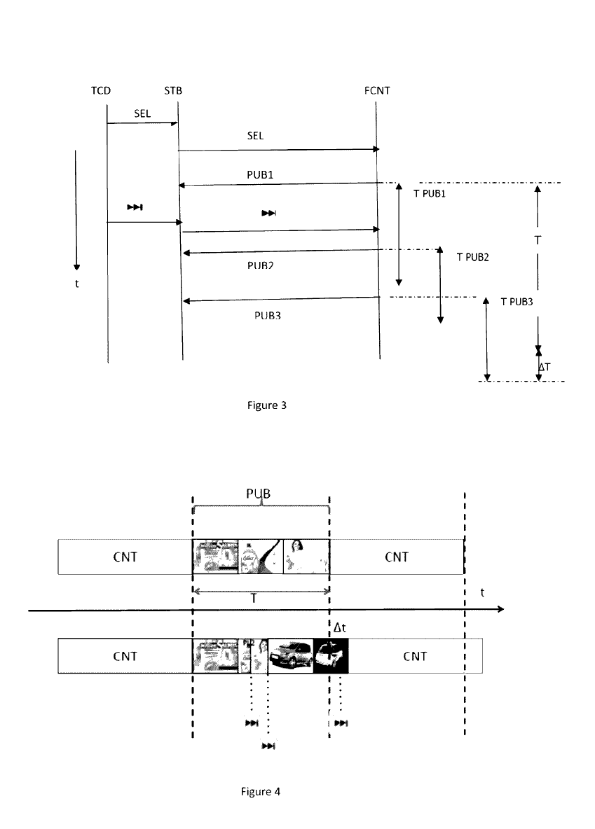

FIG. 3 illustrates this example embodiment. In this example, it is assumed that the condition is the recovery of two advertisements in their entirety in the interval T.

During the first step ET1, a command is transmitted from the remote control to the decoder, which transfers this command to the provider FCNT.

The provider then transmits to the decoder receives a first advertisement PUB1 and requests a recovery on the screen of this advertisement.

Then, during the time interval, a move-forward command is transmitted from the remote control TCD and is received by the management entity MNG during a second step ET2. At this stage, the management entity MNG then checks during a third step ET3 whether the command is a move-forward command. This is the case in our example. Consequently, the management entity requests the stoppage of the recovery of the first advertisement and requests a recovery of a new advertisement.

At the end of the recovery of the second advertisement PUB2, since the time duration T has not elapsed due to the stoppage of the first advertisement before the end of its recovery, the method continues and a third advertisement PUB3 is recovered.

In our example, the condition being the recovery of two advertisements, the third advertisement is recovered until the end beyond the time duration T. An additional time duration ΔT is therefore added to the time duration T so that the condition C is fulfilled; the additional time duration is chosen in such a way that the third advertisement can be recovered in its entirety.

According to one variant, when the time interval (T) has elapsed, if said at least one condition (C) is not fulfilled, the content manipulation commands are ignored until said at least one condition (C) is fulfilled. FIG. 4 illustrates this case; a command is transmitted in the additional time interval ΔT. The command is ignored and the recovery of the third advertisement PUB3 continues.

For the implementation of an exemplary embodiment of the invention, the management entity includes a receiving module capable of receiving a command to manipulate content of the second type in the time interval, and a management module capable of selecting a different content of the second type following the reception of a manipulation command in the interval.

It should be noted that the term entity used above may correspond to both a software component and a hardware component or an assembly of hardware and software components, a software component itself corresponding to one or more computer programs or sub-programs or generally to any element of a program capable of performing a function or a set of functions as described for the devices concerned. Similarly, a hardware component corresponds to any element of a hardware assembly capable of performing a function or a set of functions for the device concerned (integrated circuit, chip card, memory card, etc.).

Although the present disclosure has been described with reference to one or more examples, workers skilled in the art will recognize that changes may be made in form and detail without departing from the scope of the disclosure and/or the appended claims.

1. A method comprising:
managing recovery of content including content of a first type and content of a second type (PUBn) by a management device, a time interval being dedicated to reading of the content of the second type, the content being capable of being manipulated via a control device, wherein managing comprises:
receiving by the management device a command to manipulate content of the second type in the time interval, which instigates selection of a different content of the second type for recovery.

2. The method as claimed in claim 1, wherein the content of the second type is selected according to a profile created on the basis of a history of the recovered content of the second type.

3. The method as claimed in claim 2, wherein the profile is based on content of the second type recovered beyond a certain time duration.

4. The method as claimed in claim 1, wherein the management device verifies at least one condition before the recovery of the content of the first type.

5. The method as claimed in claim 3, wherein the at least one condition comprises a minimum time duration for recovery of at least one content of the second type.

6. The method as claimed in claim 4, wherein, when the time interval has elapsed, if said at least one condition is not fulfilled, the management device disables the content manipulation commands until said at least one condition is fulfilled.

7. The method as claimed in claim 1, wherein the manipulation command is one of the following commands:
a. a move-forward command relating to the content of the second type;
b. a command to transfer to the content of the first type.

8. The method as claimed in claim 1, wherein the content of the second type is advertising content.

9. A management entity comprising:
a non-transitory computer-readable medium having instructions stored thereon;
a processor, which is configured by the instructions to perform acts comprising:
managing recovery of content, including content of a first type and content of a second type, a time interval being dedicated to the reading of the content of the second type, the content being capable of being manipulated via a control device, wherein managing comprises:
receiving a command to manipulate content of the second type in the time interval, and
selecting a different content of the second type following the reception of the manipulation command in the interval.

10. A device comprising the management entity as claimed in claim 9.

11. (canceled)

12. A non-transitory computer-readable data medium on which at least one series of program code instructions has been stored for execution of a method when the instructions are executed by a processor, wherein the instructions configure the processor to perform acts comprising:
managing recovery of content including content of a first type and content of a second type, a time interval being dedicated to reading of the content of the second type, the content being capable of being manipulated via a control device, wherein managing comprises:
receiving a command to manipulate content of the second type in the time interval, which instigates selection of a different content of the second type for recovery.
